(19) United States
(12) Patent Application Publication
(10) Pub. No.: US 2026/0339259 A1
(43) Pub. Date: Oct. 29, 2026

(54) METHOD FOR ROUTING ELECTRIC WIRES CONNECTED TO HYBRID DRAWER CONNECTOR DEVICE, AND CONNECTION DEVICE

(71) Applicant: KYOCERA Document Solutions Inc., Osaka (JP)

(72) Inventors: Shizuya UEMURA, Osaka (JP); Yuhiro SAKAI, Osaka (JP)

(73) Assignee: KYOCERA Document Solutions Inc., Osaka (JP)

(21) Appl. No.: 19/648,102

(22) Filed: Apr. 15, 2026

(30) Foreign Application Priority Data
Apr. 28, 2025 (JP) 2025-074822

(51) Int. Cl. G03G 15/00; H01R 24/22; H01R 24/30; H01R 107/00

(52) U.S. Cl. CPC G03G 15/80; H01R 24/22; H01R 24/30; H01R 2107/00; H01R 2201/06

(57) ABSTRACT

A method for routing electric wires includes connecting a first electric wire transmitting AC power to a first terminal of a hybrid drawer connector device including the first terminal, a second terminal, and a third terminal; connecting a second electric wire transmitting DC power or a signal to the second terminal; and connecting a GND wire to the third terminal. The GND wire is routed so as to pass between the first electric wire and the second electric wire.

### INCORPORATION BY REFERENCE

This application claims priority to Japanese Patent Application No. 2025-074822 filed on Apr. 28, 2025, the entire contents of which are incorporated by reference herein.

### BACKGROUND

The present disclosure relates to a method for routing electric wires connected to a hybrid drawer connector device, and a connection device.

Drawer connectors for connecting lead wires (signal wires and a ground wire) between two devices have been provided.

### SUMMARY

According to an aspect of the present disclosure, a technology further improving the foregoing technology is proposed.

A method for routing electric wires according to an aspect of the present disclosure includes connecting a first electric wire transmitting alternating current (AC) power to a first terminal of a hybrid drawer connector device including the first terminal, a second terminal, and a third terminal; connecting a second electric wire transmitting direct current (DC) power or a signal to the second terminal; and connecting a GND wire to the third terminal. The GND wire is routed so as to pass between the first electric wire and the second electric wire.

A connection device according to another aspect of the present disclosure includes a hybrid drawer connector device, a first electric wire, a second electric wire, and a GND wire. The hybrid drawer connector device includes a first terminal, a second terminal, and a third terminal. The first electric wire is connected to the first terminal and transmits AC power. The second electric wire is connected to the second terminal and transmits DC power or a signal. The GND wire is connected to the third terminal. The GND wire is routed so as to pass between the first electric wire and the second electric wire.

### BRIEF DESCRIPTION OF THE DRAWINGS

FIG. 1 is a cross-sectional view showing a configuration of an image forming apparatus to which a method for routing electric wires according to an embodiment of the present disclosure is applied.

FIG. 2 is a schematic view showing a connection device to which the method for routing electric wires according to the embodiment of the present disclosure is applied.

FIG. 3 is a schematic view showing the connection device in a state where a hybrid drawer connector in FIG. 2 is assembled.

FIG. 4 is a schematic view showing the connection device viewed in a direction different from that in FIG. 3.

FIG. 5A is a schematic view showing one hybrid drawer connector device constituting the hybrid drawer connector in FIG. 1.

FIG. 5B is a schematic view showing the other hybrid drawer connector device.

### DETAILED DESCRIPTION

Hereinafter, a method for routing electric wires according to an embodiment of the present disclosure will be described with reference to the accompanying drawings.

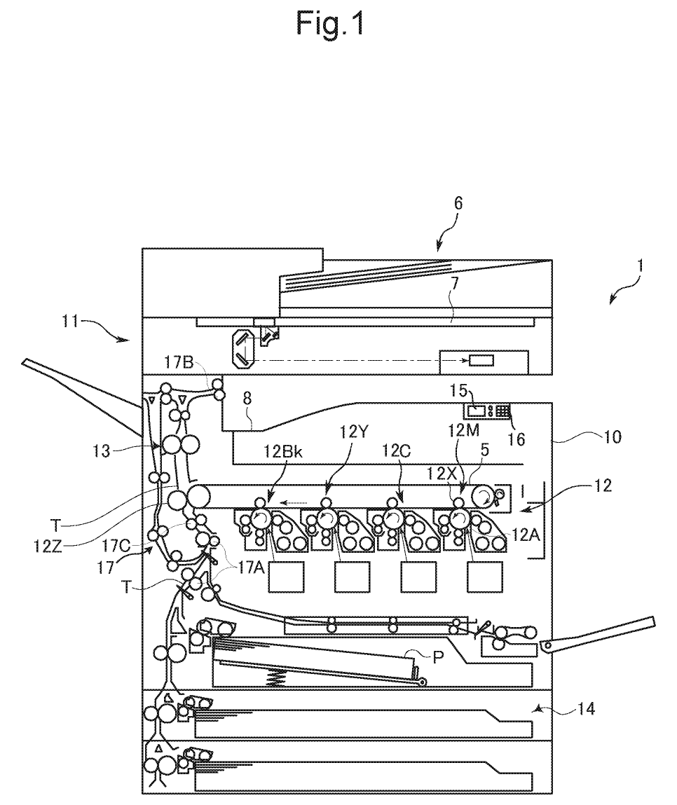

First, a configuration of an image forming apparatus 1 to which the method for routing electric wires according to the embodiment of the present disclosure is applied will be described with reference to FIG. 1. FIG. 1 is a cross-sectional view showing a configuration of an image forming apparatus to which the method for routing electric wires according to the embodiment of the present disclosure is applied. For example, the image forming apparatus 1 is a multifunction peripheral having a plurality of functions such as a copying function, a transmitting function, a printing function, and a faxing function.

The image forming apparatus 1 includes a housing 10, a document transport device 6 placed on the housing 10, a document reading device 11 provided in the housing 10, an image forming device 12, a fixing device 13, a paper feeding device 14, a display device 15, an operation device 16, and a transport device 17. The document transport device 6 transports documents placed on a document holder one sheet at a time to a reading position of the document reading device 11. The document transport device 6 is configured to turn in a vertical direction about a pivot on the rear side of the page in FIG. 1 so as to be capable of opening and closing a platen glass 7. The document transport device 6 also functions as a cover pressing a document on the platen glass 7 from above. The document reading device 11 is a scanner optically reading a document and generating image data for depicting a document image. The document reading device 11 reads a document transported by the document transport device 6 or a document placed on the platen glass 7.

The image forming device 12 includes a photosensitive drum, a charging apparatus, an exposure apparatus, a developing apparatus, and a transfer apparatus. The exposure apparatus includes a laser scanning unit (LSU). The image forming device 12 forms a toner image on paper P transported by the transport device 17 along a transport path T on the basis of image data. For example, when color printing is performed, a magenta image forming unit 12M, a cyan image forming unit 12C, a yellow image forming unit 12Y, and a black image forming unit 12Bk of the image forming device 12 respectively form a magenta toner image, a cyan toner image, a yellow toner image, and a black toner image on a photosensitive drum 12A through steps of charging, exposure, and development. The formed toner images of the respective colors are transferred and superimposed on an intermediate transfer belt 5 by a primary transfer roller 12X, thereby forming a color toner image. The superimposed color toner image is transferred onto the paper P transported within the transport path T by a secondary transfer roller 12Z. The fixing device 13 heats and pressurizes the paper P on which the toner image has been formed and fixes the toner image onto the paper P. The paper P on which the toner image has been formed is discharged to a discharge tray 8. The paper feeding device 14 includes a manual feeding tray and a plurality of paper feeding cassettes. The paper feeding device 14 draws out the paper P accommodated in one of the plurality of paper feeding cassettes or paper placed on the manual feeding tray one sheet at a time using a pickup roller, and feeds it to the transport path T. The paper P is not limited to paper media and may be overhead projector (OHP) sheets, for example.

The display device 15 includes a liquid crystal display or an organic EL (organic light-emitting diode) display. The display device 15 displays various screens. The operation device 16 includes a plurality of hardware keys such as a start key for inputting an instruction to start execution of copying processing, scanning processing, or the like, and a touch panel disposed over the display device 15. A user instruction is input to the operation device 16.

The transport device 17 includes a transport roller pair 17A, a discharge roller pair 17B, a registration roller 17C, and the like as well as a transport motor. When the transport motor drives the transport roller pair 17A, the discharge roller pair 17B, the registration roller 17C, and the like to rotate, the paper P fed by the paper feeding device 14 is transported to the image forming device 12, the fixing device 13, and the like along the transport path T.

The image forming apparatus 1 further includes a control device (not shown). The control device includes a processor, a random access memory (RAM), a read only memory (ROM), and the like. For example, the processor is a central processing unit (CPU), a micro-processing unit (MPU), an application specific integrated circuit (ASIC), or the like. When a control program or the like stored in the foregoing ROM is executed by the foregoing processor, the control device functions as a controller controlling operation of the document transport device 6, the document reading device 11, the image forming device 12, the fixing device 13, the paper feeding device 14, the display device 15, the operation device 16, the transport device 17, and the like.

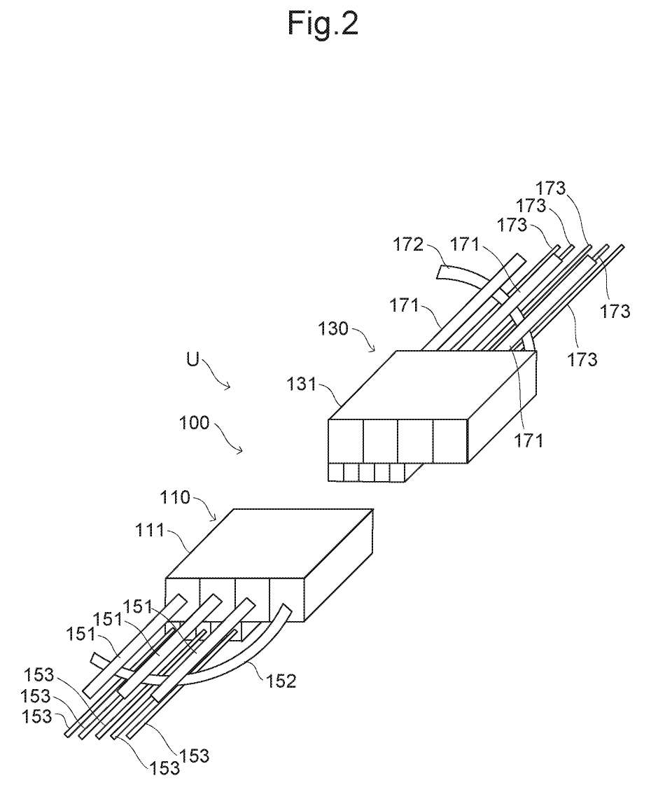

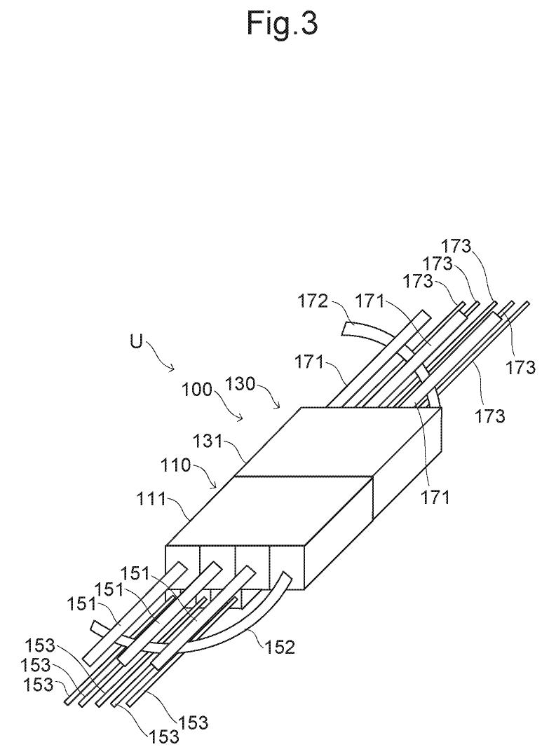

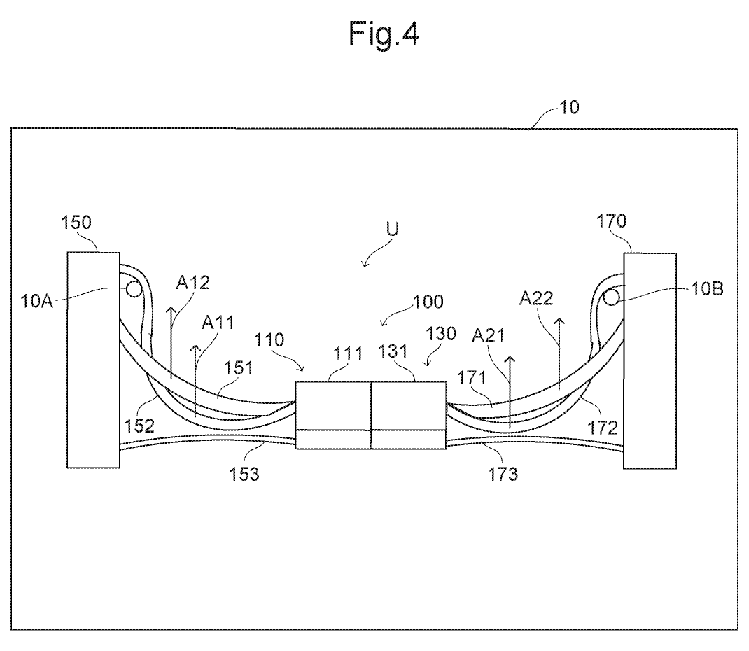

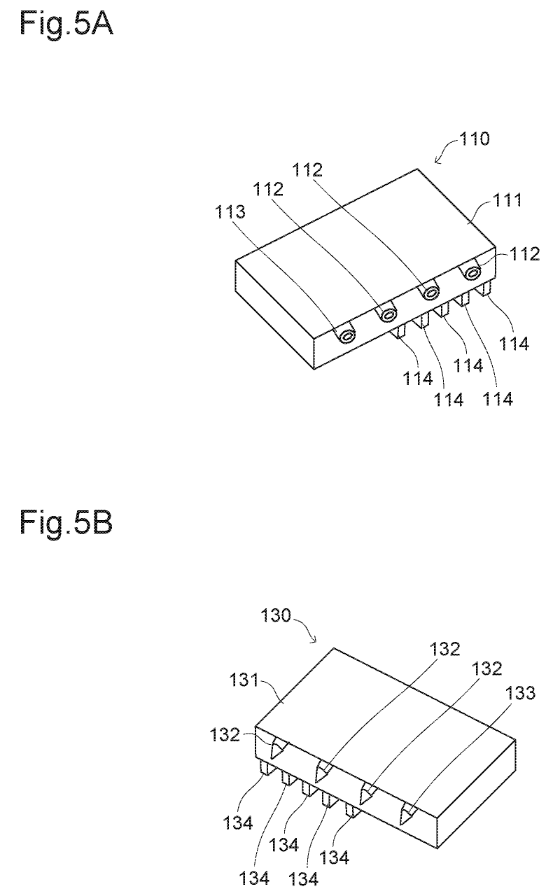

Subsequently, the method for routing electric wires according to the embodiment of the present disclosure will be described with reference to FIGS. 2-5B. FIG. 2 is a schematic view showing a connection device U to which the method for routing electric wires according to the embodiment of the present disclosure is applied. FIG. 3 is a schematic view showing the connection device U in a state where a hybrid drawer connector 100 in FIG. 2 is assembled. FIG. 4 is a schematic view showing the connection device U viewed in a direction different from that in FIG. 3. FIG. 5A is a schematic view showing one hybrid drawer connector device 110 constituting the hybrid drawer connector 100 in FIG. 1. FIG. 5B is a schematic view showing the other hybrid drawer connector device 130 of the hybrid drawer connector 100 in FIG. 1. As shown in FIGS. 2-4, the connection device U includes the hybrid drawer connector 100, and first electric wires 151 and 171, GND wires 152 and 172, and second electric wires 153 and 173 which are connected to the hybrid drawer connector 100.

As shown in FIGS. 2-4, the hybrid drawer connector 100 includes a pair of hybrid drawer connector devices 110 and 130. Hereinafter, the hybrid drawer connector 100 will be referred to as the drawer connector 100, and the hybrid drawer connector devices 110 and 130 will be referred to simply as the drawer connector devices 110 and 130.

As shown in FIG. 5A, for example, the drawer connector device 110 includes a resin main body 111, three conductive first terminals 112 and one third terminal 113 provided in the main body 111, and five conductive second terminals 114 provided in the main body 111. The three first terminals 112 and the one third terminal 113 are arranged in a row, and the third terminal 113 is disposed on the outward side of the three first terminals 112. In addition, the five second terminals 114 are arranged in a row parallel to the four terminals in total including the three first terminals 112 and the one third terminal 113. The four terminals in total including the three first terminals 112 and the one third terminal 113, and the five second terminals 114 are provided in the main body 111 such that a first region between a plane orthogonal to one direction in which the four terminals in total including the three first terminals 112 and the one third terminal 113 are arranged and including a terminal position at one end in the one direction and a plane orthogonal to the one direction and including a terminal position at the other end in the one direction overlaps a second region between a plane orthogonal to one direction in which the five second terminals 114 are arranged and including a terminal position at one end in the one direction and a plane orthogonal to the one direction and including the terminal position at the other end in the one direction. In the present embodiment, the four terminals in total including the three first terminals 112 and the one third terminal 113, and the five second terminals 114 are provided in the main body 111 such that the foregoing second region in its entirety is included in the foregoing first region.

Three first electric wires 151 transmitting AC power are connected to the three first terminals 112. In addition, one GND wire 152 corresponding to the first electric wire 151 is connected to the one third terminal 113. Five second electric wires 153 are connected to the five second terminals 114. Each of the five second electric wires 153 is an electric wire transmitting DC power or a signal.

When the other ends of the three first electric wires 151, the one GND wire 152, and the five second electric wires 153 whose one ends are connected to the drawer connector device 110 are attached to a first device 150 inside the image forming apparatus 1 (for example, the control device of the image forming apparatus 1), the GND wire 152 is routed so as to pass between the three first electric wires 151 and the five second electric wires 153, as shown in FIGS. 2-4. After passing between the three first electric wires 151 and the five second electric wires 153, as shown in FIG. 4, the GND wire 152 is routed in a direction away from the five second electric wires 153. In the present embodiment, a protrusion 10A of the housing 10, the third terminal 113, and the second terminals 114 are arranged in this order in one direction, and the GND wire 152 is hooked onto the protrusion 10A and routed in a direction away from the five second electric wires 153 (direction of arrow A11 in FIG. 4). At this time, the GND wire 152 pushes the three first electric wires 151 in a direction away from the five second electric wires 153 (direction of arrow A12 in FIG. 4), thereby moving the three first electric wires 151 in a direction away from the five second electric wires 153 (direction of arrow A12 in FIG. 4).

As shown in FIG. 5B, for example, the drawer connector device 130 includes a resin main body 131, three conductive first terminals 132 and one third terminal 133 provided in the main body 131, and five conductive second terminals 134 provided in the main body 131. The main body 131 is configured to be detachably attached to the main body 111 of the drawer connector device 110. The three first terminals 132 and the one third terminal 133 are provided at positions in the main body 131 corresponding to the three first terminals 112 and the one third terminal 113 of the drawer connector device 110. The three first terminals 132 and the one third terminal 133 are arranged in a row, and the third terminal 133 is disposed on the outward side of the three first terminals 132. In addition, the five second terminals 134 are provided at positions in the main body 131 corresponding to the five second terminals 114 of the drawer connector device 110. The five second terminals 134 are arranged in a row parallel to the four terminals in total including the three first terminals 132 and the one third terminal 133. The four terminals in total including the three first terminals 132 and the one third terminal 133, and the five second terminals 134 are provided in the main body 131 such that a first region between a plane orthogonal to one direction in which the four terminals in total including the three first terminals 132 and the one third terminal 133 are arranged and including a terminal position at one end in one direction and a plane orthogonal to the one direction and including a terminal position at the other end in the one direction overlaps a second region between a plane orthogonal to one direction in which the five second terminals 134 are arranged and including a terminal position at one end in the one direction and a plane orthogonal to the one direction and including the terminal position at the other end in the one direction. In the present embodiment, the four terminals in total including the three first terminals 132 and the one third terminal 133, and the five second terminals 134 are provided in the main body 131 such that the foregoing second region in its entirety is included in the foregoing first region.

Three first electric wires 171 transmitting AC power are connected to the three first terminals 132. In addition, one GND wire 172 corresponding to the first electric wire 171 is connected to the one third terminal 133. Five second electric wires 173 are connected to the five second terminals 134. Each of the five second electric wires 173 is an electric wire transmitting DC power or a signal.

When the other ends of the three first electric wires 171, the one GND wire 172, and the five second electric wires 173 whose one ends are connected to the drawer connector device 130 are attached to a second device 170 inside the image forming apparatus 1 (for example, the document transport device 6 of the image forming apparatus 1), the GND wire 172 is routed so as to pass between the three first electric wires 171 and the five second electric wires 173, as shown in FIGS. 2-4. After passing between the three first electric wires 171 and the five second electric wires 173, as shown in FIG. 4, the GND wire 172 is routed in a direction away from the five second electric wires 173. In the present embodiment, a protrusion 10B of the housing 10, the third terminal 133, and the second terminals 134 are arranged in this order in one direction, and the GND wire 172 is hooked onto the protrusion 10B and routed in a direction away from the five second electric wires 173 (direction of arrow A21 in FIG. 4). At this time, the GND wire 172 pushes the three first electric wires 171 in a direction away from the five second electric wires 173 (direction of arrow A22 in FIG. 4), thereby moving the three first electric wires 171 in a direction away from the five second electric wires 173 (direction of arrow A22 in FIG. 4).

When the main body 131 of the drawer connector device 130 is attached to the main body 111 of the drawer connector device 110, the three first terminals 112, the one third terminal 113, and the five second terminals 114 of the drawer connector device 110 come into contact with the three first terminals 132, the one third terminal 133, and the five second terminals 134 of the drawer connector device 130, respectively. Accordingly, the three first electric wires 151, the one GND wire 152, and the five second electric wires 153 are electrically connected to the three first electric wires 171, the one GND wire 172, and the five second electric wires 173, respectively. The GND wires 152 and 172 are used for aligning reference potentials of the first device 150 to which the other end of the GND wire 152 is connected, and the second device 170 to which the other end of the GND wire 172 is connected.

According to the foregoing embodiment, in the drawer connector device 110, by causing the one GND wire 152 to pass between the three first electric wires 151 and the five second electric wires 153, contact between the three first electric wires 151 and the five second electric wires 153 can be prevented, and a space can be secured between the three first electric wires 151 and the five second electric wires 153. Therefore, it is possible to reduce interference with the DC power or a signal transmitted through the second electric wire 153 due to noise generated by the AC power transmitted through the first electric wires 151. In addition, in the drawer connector device 130, by causing the one GND wire 172 to pass between the three first electric wires 171 and the five second electric wires 173, contact between the three first electric wires 171 and the five second electric wires 173 can be prevented, and a space can be secured between the three first electric wires 171 and the five second electric wires 173. Therefore, it is possible to reduce interference with the DC power or a signal transmitted through the second electric wire 173 due to noise generated by the AC power transmitted through the first electric wires 171.

In addition, in the drawer connector device 110, since the GND wire 152 moves the three first electric wires 151 in a direction away from the five second electric wires 153, a larger space can be secured between the three first electric wires 151 and the five second electric wires 153. Therefore, it is possible to further reduce interference with the DC power or a signal transmitted through the second electric wire 153 due to noise generated by the AC power transmitted through the first electric wires 151. In addition, in the drawer connector device 130, since the GND wire 172 moves the three first electric wires 171 in a direction away from the five second electric wires 173, a larger space can be secured between the three first electric wires 171 and the five second electric wires 173. Therefore, it is possible to further reduce interference with the DC power or a signal transmitted through the second electric wire 173 due to noise generated by the AC power transmitted through the first electric wires 171.

In addition, in the drawer connector device 110, since the one third terminal 113 connecting the one GND wire 152 is located on the outward side of the three first terminals 112 to which the three first electric wires 151 are connected, wiring of the one GND wire 152 causing the one GND wire 152 to pass between the three first electric wires 151 and the five second electric wires 153 can be realized with simple routing. In addition, in the drawer connector device 130, since the one third terminal 133 connecting the one GND wire 172 is located on the outward side of the three first terminals 132 to which the three first electric wires 171 are connected, wiring of the one GND wire 172 causing the one GND wire 172 to pass between the three first electric wires 171 and the five second electric wires 173 can be realized with simple routing.

Incidentally, regarding drawer connectors, there are hybrid drawer connectors including a first terminal to which the first electric wire transmitting the AC power is connected, a second terminal to which the second electric wire transmitting the DC power or a signal is connected, and a third terminal to which a ground (GND) wire is connected.

In such hybrid drawer connectors, noise generated by the AC power transmitted through the first electric wire interferes with the DC power or a signal transmitted through the second electric wire.

The present embodiment reduces interference with the DC power or a signal transmitted through the second electric wire due to noise generated by the AC power transmitted through the first electric wire.

The present disclosure is not limited to the configurations of the foregoing embodiment, and various modifications are possible.

For example, in the foregoing embodiment, in routing in which the one GND wire 152 is caused to pass between the three first electric wires 151 and the five second electric wires 153, the one GND wire 152 is routed in a direction away from the five second electric wires 153, and the GND wire 152 pushes the three first electric wires 151 in a direction away from the five second electric wires 153, thereby moving the three first electric wires 151 in a direction away from the five second electric wires 153. However, the disclosure is not limited thereto. For example, in routing in which the one GND wire 152 is caused to pass between the three first electric wires 151 and the five second electric wires 153, the one GND wire 152 may be routed in a direction away from the three first electric wires 151, and the GND wire 152 may push the five second electric wires 153 in a direction away from the three first electric wires 151, thereby moving the five second electric wires 153 in a direction away from the three first electric wires 151. In addition, in routing in which the one GND wire 172 is caused to pass between the three first electric wires 171 and the five second electric wires 173, the one GND wire 172 is routed in a direction away from the five second electric wires 173, and the GND wire 172 pushes the three first electric wires 171 in a direction away from the five second electric wires 173, thereby moving the three first electric wires 171 in a direction away from the five second electric wires 173. However, the disclosure is not limited thereto. For example, in routing in which the one GND wire 172 is caused to pass between the three first electric wires 171 and the five second electric wires 173, the one GND wire 172 may be routed in a direction away from the three first electric wires 171, and the GND wire 172 may push the five second electric wires 173 in a direction away from the three first electric wires 171, thereby moving the five second electric wires 173 in a direction away from the three first electric wires 171.

In addition, in the foregoing embodiment, the number of each of the first electric wires 151 and 171 is set to three, the number of each of the GND wires 152 and 172 is set to one, and the number of each of the second electric wires 153 and 173 is set to five. However, the disclosure is not limited thereto. The number of each of the first electric wires 151 and 171 may be set to one or larger, the number of each of the GND wires 152 and 172 may be set to one or larger, and the number of each of the second electric wires 153 and 173 may be set to one or larger, other than those described above.

In addition, in the foregoing embodiment, the method for routing electric wires which has been described using FIGS. 2-5B can be applied to electronic equipment other than the image forming apparatus 1.

In addition, the configurations shown in the foregoing embodiment using FIGS. 1-5B, and the configurations shown in the foregoing modification example are merely embodiments of the present disclosure, and the present disclosure is not intended to be limited to these configurations.

While the present disclosure has been described in detail with reference to the embodiments thereof, it would be apparent to those skilled in the art that the various changes and modifications may be made therein within the scope defined by the appended claims.

What is claimed is:

1. A method for routing electric wires comprising:
connecting a first electric wire transmitting alternating current (AC) power to a first terminal of a hybrid drawer connector device including the first terminal, a second terminal, and a third terminal;
connecting a second electric wire transmitting direct current (DC) power or a signal to the second terminal; and
connecting a ground (GND) wire to the third terminal,
wherein the GND wire is routed so as to pass between the first electric wire and the second electric wire.

2. The method for routing electric wires according to claim 1,
wherein the GND wire moves the first electric wire in a direction away from the second electric wire.

3. The method for routing electric wires according to claim 1,
wherein a plurality of the first terminals to which a plurality of the first electric wires are connected and the third terminal are arranged in a row, and the third terminal is disposed on an outward side of the plurality of the first terminals.

4. A connection device comprising:
a hybrid drawer connector device including a first terminal, a second terminal, and a third terminal;
a first electric wire connected to the first terminal and transmitting alternating current (AC) power;
a second electric wire connected to the second terminal and transmitting direct current (DC) power or a signal; and
a ground (GND) wire connected to the third terminal,
wherein the GND wire is routed so as to pass between the first electric wire and the second electric wire.

5. The connection device according to claim 4,
wherein a plurality of the first terminals to which a plurality of the first electric wires are connected and the third terminal are arranged in a row, and the third terminal is disposed on an outward side of the plurality of the first terminals, and
a plurality of the second terminals connected to a plurality of the second electric wires are arranged in a row parallel to the plurality of the first terminals and the third terminal.
